(19) United States
(12) Patent Application Publication
(10) Pub. No.: US 2026/0077412 A1
(43) Pub. Date: Mar. 19, 2026

(54) Cartridge for Cutting Tools and Associated Tool Assembly

(71) Applicant: Kennametal Inc., Latrobe, PA (US)

(72) Inventors: Logan Semnisky, Latrobe, PA (US); John Musil, Latrobe, PA (US); Jacob Crawford, Latrobe, PA (US); Scott Rusnock, Latrobe, PA (US)

(73) Assignee: Kennametal Inc., Latrobe, PA (US)

(21) Appl. No.: 18/886,246

(22) Filed: Sep. 16, 2024

(51) Int. Cl. B23C 5/24

(52) U.S. Cl. CPC B23C 5/2472

(57) ABSTRACT

An example cartridge for a cutting tool system has a cartridge main body that has a cartridge main body first end, a cartridge main body second end, a first terminal wall, a second terminal wall, and an insert pocket. Each of the first terminal wall and the second terminal wall is disposed on the cartridge main body second end. The insert pocket extends from the cartridge main body second end toward the cartridge main body first end and has an axial pocket wall, a radial pocket wall, and an insert pocket floor. The axial pocket wall extends from the first terminal wall, toward the cartridge main body first end, and to the insert pocket floor. The radial pocket wall extends from the second terminal wall, toward the cartridge main body first end, and to the insert pocket floor.

### FIELD

The disclosure relates generally to the field of cutting tools. More particularly, the disclosure relates to a cartridge for cutting tools and an associated tool assembly.

### BACKGROUND

Cutting tools, such as inserts, are generally installed in a cartridge, which is then assembled in a tool assembly such that work can be completed on a workpiece. Slight variations in the dimensions of the cutting tool and its associated cartridge can accumulate, which is generally referred to as insert tolerance stackup. While each component may have acceptable individual tolerances, these minor deviations can add up during assembly, which can cause the cutting tool, such as an insert, to be misaligned or positioned at a less-than-ideal angle. This results in a reduction of the cutting accuracy of the insert, poor surface finishes on the workpiece, and even a shortened lifespan for the tool itself. To minimize insert tolerance stackup, machinists currently rely on adjustable inserts or cartridges, or tighter tolerance inserts and cartridges, along with regular tool inspection to ensure consistent and reliable performance.

A need exists, therefore, for new and useful cartridges for cutting tools and associated tool assemblies.

### SUMMARY

Various example cartridges for a cutting tool and associated tool assemblies are described.

An example cartridge for a cutting tool has a cartridge main body that has a cartridge main body first end, a cartridge main body second end, a first terminal wall, a second terminal wall, an insert pocket, a cartridge main body passageway, and a cartridge main body recess. Each of the first terminal wall and the second terminal wall is disposed on the cartridge main body second end. The insert pocket extends from the cartridge main body second end toward the cartridge main body first end and has an axial pocket wall, a radial pocket wall, and an insert pocket floor. The axial pocket wall extends from the first terminal wall, toward the cartridge main body first end, and to the insert pocket floor. The radial pocket wall extends from the second terminal wall, toward the cartridge main body first end, and to the insert pocket floor. The cartridge main body passageway is disposed between the cartridge main body first end and the insert pocket floor. The cartridge main body recess extends from the insert pocket floor and toward the cartridge main body first end.

An example tool assembly has a tool body, a bearing housing, a first bearing, and a second bearing. The tool body is rotatable around a tool body central axis and has a tool body first end, a tool body second end, a tool body periphery, a tool body central recess, a cartridge pocket, and a chip pocket. The tool body central recess extends from the tool body second end toward the tool body first end. The cartridge pocket extends from the tool body periphery and to the tool body central recess. The chip pocket extends from the cartridge pocket and toward the tool body first end. The bearing housing is attached to the tool body and has a bearing housing central axis, a bearing housing first end, a bearing housing second end, a bearing housing central passageway, and a bearing housing projection that extends into the bearing housing central passageway. The first bearing is disposed within the bearing housing between the bearing housing projection and the tool body. The second bearing is disposed within the bearing housing between the bearing housing projection and the bearing housing second end.

Additional understanding of these examples can be obtained by review of the detailed description, below, and the appended drawings.

### BRIEF DESCRIPTION OF THE DRAWINGS

FIG. 1 is a perspective view of an example cartridge for a cutting tool. FIG. 1 illustrates the cartridge with an indexable cutting insert and two fasteners for reference.

FIG. 2 is an exploded view of the cartridge shown in FIG. 1. FIG. 2 illustrates the cartridge with an indexable cutting insert and two fasteners for reference.

FIG. 3 is a partial end view of the cartridge shown in FIG. 1. FIG. 3 illustrates the cartridge with an indexable cutting insert and two fasteners for reference.

FIG. 4 is a partial top view of the cartridge shown in FIG. 1. FIG. 4 illustrates the cartridge with an indexable cutting insert for reference.

FIG. 5 is a partial side view of the cartridge shown in FIG. 1. FIG. 4 illustrates the cartridge with an indexable cutting insert for reference.

FIG. 6 is a top view of the cartridge shown in FIG. 1.

FIG. 7 is a bottom view of the cartridge shown in FIG. 1.

FIG. 8 is a side view of the cartridge shown in FIG. 1.

FIG. 9 is another side view of the cartridge shown in FIG. 1.

FIG. 10 is an end view of the cartridge shown in FIG. 1.

FIG. 11 is another end view of the cartridge shown in FIG. 1.

FIG. 12 is a perspective view of an example tool assembly that includes a cartridge for a cutting tool.

FIG. 13 is an end view of the tool assembly shown in FIG. 12.

FIG. 14 is an exploded view of the tool assembly shown in FIG. 12.

FIG. 15 is a sectional view of the tool assembly shown in FIG. 12 taken along the tool body central axis.

FIG. 16 is a perspective view of the bearing housing of the tool assembly shown in FIG. 12.

FIG. 17 is a sectional view of the tool assembly shown in FIG. 12 taken perpendicular to the tool body central axis.

FIG. 18 is a perspective view of the tool body of the tool assembly shown in FIG. 12.

FIG. 19 is a partial perspective view of the tool assembly shown in FIG. 12.

FIG. 20 is another sectional view of the tool assembly shown in FIG. 12 taken perpendicular to the tool body central axis.

FIG. 21 is another perspective view of the tool body of the tool assembly shown in FIG. 12.

FIG. 22 is another partial perspective view of the tool assembly shown in FIG. 12.

FIG. 23 is an end view of the tool assembly shown in FIG. 12. The bearing housing, the first bearing, and the second bearing have been omitted for clarity.

FIG. 24 is another perspective view of the tool body of the tool assembly shown in FIG. 12.

FIG. 25 is another partial perspective view of the tool assembly shown in FIG. 12.

### DETAILED DESCRIPTION

The following detailed description and the appended drawings describe and illustrate various example embodiments of a cartridge for a cutting tool and an associated tool assembly. The description and illustration of these examples are provided to enable one skilled in the art to make and use a cartridge for a cutting tool and a tool assembly according to this invention. They are not intended to limit the scope of the claims in any manner.

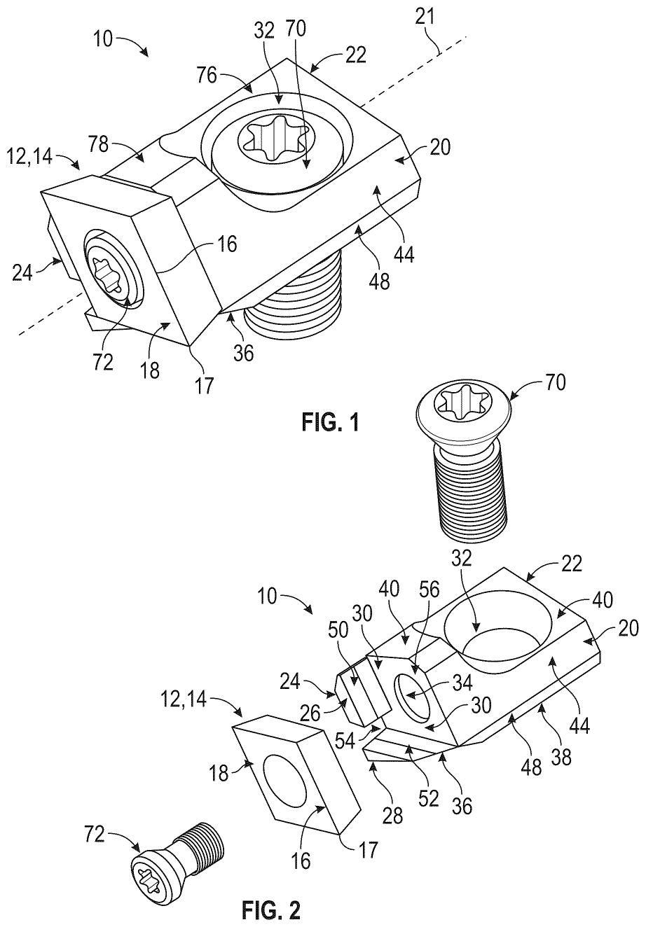

FIGS. 1 through 11 illustrate a first example cartridge 10 for a cutting tool 12. In the illustrated embodiment, the cutting tool 12 is an indexable cutting insert 14.

The cartridge 10 has a cartridge main body 20 that has a cartridge main body lengthwise axis 21, a cartridge main body first end 22, a cartridge main body second end 24, a first terminal wall 26, a second terminal wall 28, an insert pocket 30, a cartridge main body passageway 32, a cartridge main body recess 34, a radial cartridge clearance surface 36, a radial cartridge floor 38, a cartridge ceiling 40, an axial cartridge wall 42, a second cartridge wall 44, a first cartridge chamfer 46, and a second cartridge chamfer 48.

In the illustrated embodiment, each of the first terminal wall 26 and the second terminal wall 28 is disposed on the cartridge main body second end 24 and on a hypothetical plane 23 that is disposed perpendicular to the cartridge main body lengthwise axis 21. However, in alternative embodiments, a first terminal wall and a second terminal wall can be positioned at any suitable location on a cartridge main body and on any suitable number of planes, disposed at any suitable angle relative to one another. The first terminal wall 26 has a first terminal wall first width 27 measured along the cartridge ceiling 40 and a first terminal wall second width 29 measured from the axial cartridge wall 42 to the insert pocket 30. The first terminal wall second width 29 is greater than the first terminal wall first width 27. The second terminal wall 28 has a second terminal wall first width 31 measured along the axial cartridge wall 42 and a second terminal wall second width 33 measured between the axial cartridge wall 42 and the insert pocket 30. In the illustrated embodiment, the second terminal wall second width 33 is less than the second terminal wall first width 31. However, in alternative embodiments, a second terminal wall second width can be equal to, or greater than, a second terminal wall first width.

The insert pocket 30 extends from the cartridge main body second end 24 toward the cartridge main body first end 22 and has an axial pocket wall 50, a radial pocket wall 52, an insert pocket recess 54, and an insert pocket floor 56. The insert pocket 30 is sized and configured to receive the cutting tool 12, such as the indexable cutting insert 14. While an insert pocket recess 54 has been illustrated, alternative embodiments can omit the inclusion of an insert pocket recess and include alternative structure, such as extending an axial pocket wall to a radial pocket wall, including a drilled corner, and any other structure considered suitable for a particular embodiment.

The axial pocket wall 50 extends from the first terminal wall 26, toward the cartridge main body first end 22, and to the insert pocket floor 56 and from the cartridge ceiling 40 to the insert pocket recess 54. The axial pocket wall 50 has an axial pocket wall length 51, an axial pocket wall depth 53, an axial pocket wall first portion 58, and an axial pocket wall second portion 60. The axial pocket wall length 51 extends from the cartridge ceiling 40 to the insert pocket recess 54. The axial pocket wall depth 53 extends from the cartridge main body second end 24 to the insert pocket floor 56.

The axial pocket wall 50 is disposed at an angle 55 relative to the radial cartridge floor 38. The angle 55 can be any suitable angle, such as those between 80 degrees and 110 degrees, those substantially equal to 90 degrees, and any other angle considered suitable for a particular embodiment. The axial pocket wall 50 is disposed at an angle 57 relative to the radial pocket wall 52. The angle 57 can be any suitable angle, such as those between 98 degrees and 102 degrees, those substantially equal to 100 degrees, and any other angle considered suitable for a particular embodiment. The axial pocket wall first portion 58 extends from the insert pocket floor 56, toward the cartridge main body second end 24, and to the axial pocket wall second portion 60. The axial pocket wall second portion 60 extends from the axial pocket wall first portion 58 to the cartridge main body second end 24. The axial pocket wall second portion 60 is disposed at an angle 59 relative to the axial pocket wall first portion 58. The angle 59 can be any suitable angle, such as those between 180 degrees and 200 degrees, those substantially equal to 189.5 degrees, those greater than 180 degrees, and any other angle considered suitable for a particular embodiment. The axial pocket wall 50 is disposed at an angle 61 relative to the insert pocket floor 56. The angle 61 can be any suitable angle, such as those between 80 degrees and 100 degrees, those substantially equal to 90 degrees, and any other angle considered suitable for a particular embodiment. While the axial pocket wall 50 has been illustrated as having an axial pocket wall first portion 58 and an axial pocket wall second portion 60, alternative embodiments can include an axial pocket wall that includes only a single portion (e.g., single surface).

The radial pocket wall 52 extends from the second terminal wall 28, toward the cartridge main body first end 22, and to the insert pocket floor 56 and from the axial cartridge wall 42 to the second cartridge chamfer 48. The radial pocket wall 52 has a radial pocket wall length 63, a radial pocket wall depth 65, a radial pocket wall first portion 62, and a radial pocket wall second portion 64. In the embodiment shown, the radial pocket wall length 63 extends from the axial cartridge wall 42 to the second cartridge wall 44 and is greater than the axial pocket wall length 51. However, in alternative embodiments, a radial pocket wall length can be less than, or equal to, an axial pocket wall length. The radial pocket wall depth 65 extends from the cartridge main body second end 24 to the insert pocket floor 56 and is equal to the axial pocket wall depth 53. The radial pocket wall first portion 62 extends from the insert pocket floor 56, toward the cartridge main body second end 24, and to the radial pocket wall second portion 64. The radial pocket wall second portion 64 extends from the radial pocket wall first portion 62 to the cartridge main body second end 24.

The radial pocket wall 52 is disposed at an angle 67 relative to the radial cartridge clearance surface 36. The angle 67 can be any suitable angle, such as shallow angles, those between 9 degrees and 11 degrees, those substantially equal to 10 degrees, and any other angle considered suitable for a particular embodiment and to minimize tolerance stackup. The axial pocket wall first portion 58 is disposed at an angle 69 relative to the radial pocket wall first portion 62. The angle 69 can be any suitable angle, such as those between 98 degrees and 102 degrees, those substantially equal to 100 degrees, and any other angle considered suitable for a particular embodiment. The axial pocket wall second portion 60 is disposed at an angle 71 relative to the radial pocket wall second portion 64. The angle 71 can be any suitable angle, such as those between 101 degrees and 102 degrees, those substantially equal to 101 degrees, and any other angle considered suitable for a particular embodiment. The radial pocket wall second portion 64 disposed at an angle 73 relative to the radial pocket wall first portion 62. The angle 73 can be any suitable angle, such as those between 180 degrees and 200 degrees, those substantially equal to 189.5 degrees, those greater than 180 degrees, and any other angle considered suitable for a particular embodiment. The radial pocket wall 52 is disposed at an angle 75 relative to the insert pocket floor 56. The angle 75 can be any suitable angle, such as those between 80 degrees and 100 degrees, those substantially equal to 90 degrees, those substantially equal to 99.5 degrees, and any other angle considered suitable for a particular embodiment. While the radial pocket wall 52 has been illustrated as having a radial pocket wall first portion 62 and a radial pocket wall second portion 64, alternative embodiments can include a radial pocket wall that includes only a single portion (e.g., single surface).

The insert pocket recess 54 is disposed between the first terminal wall 26 and the second terminal wall 28 and between the axial pocket wall 50 and the radial pocket wall 52. The insert pocket recess 54 extends from the axial cartridge wall 42 to the insert pocket floor 56 and from the cartridge main body second end 24, toward the cartridge main body first end 22, and to the insert pocket floor 56.

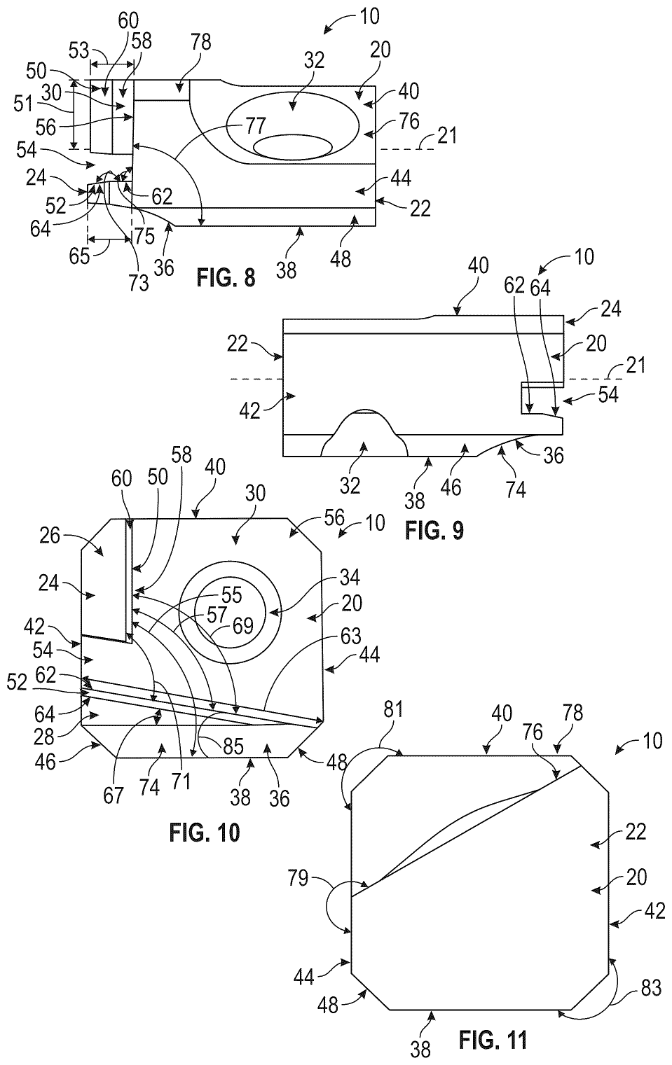

As shown in FIGS. 6 and 8, the insert pocket floor 56 is perpendicular relative to the cartridge main body lengthwise axis 21 and is disposed at an angle 77 relative to the radial cartridge floor 38 that is substantially equal to 90 degrees. The insert pocket floor 56 is parallel to the cartridge main body second end 24. However, in alternative embodiments an insert pocket floor can be disposed at any suitable angle relative to a cartridge main body lengthwise axis and/or a cartridge main body second end. The radial cartridge floor 38 is disposed at an angle 83 relative to the axial cartridge wall 42 that is substantially equal to 90 degrees, which sets the angle the cartridge 10 is positioned when mounted in a tool body, as described in more detail herein. The radial pocket wall 52 is disposed at an angle 85 relative to the radial cartridge floor 38. The angle 85 can be any suitable angle, such as shallow angles, those between 9 degrees and 11 degrees, angles between 0 degrees and 20 degrees, those substantially equal to 10 degrees, and any other angle considered suitable for a particular embodiment and to minimize tolerance stackup.

The cartridge main body passageway 32 is disposed between the cartridge main body first end 22 and the insert pocket floor 56. The cartridge main body passageway 32 extends from the cartridge ceiling 40 to the radial cartridge floor 38, the axial cartridge wall 42, and the first cartridge chamfer 46. The cartridge main body passageway 32 receives a threaded fastener 70 such that the cartridge 10 can be releasably attached to a tool body, as described in more detail herein. When assembled within a tool assembly, the position of the cartridge main body passageway 32 sets the position of the cartridge center height within the tool body central recess 138, as described in more detail herein. In the illustrated embodiment, the cartridge main body passageway 32 is countersunk, which assists with positioning the cartridge 10 during use.

The cartridge main body recess 34 is disposed between the radial cartridge floor 38 and the cartridge ceiling 40. The cartridge main body recess 34 extends from the insert pocket floor 56 and toward the cartridge main body first end 22. The cartridge main body recess 34 receives a threaded fastener 72 such that the cutting tool 12 (e.g., indexable cutting insert 14) can be releasably attached to the cartridge 10. The insert 14 is positioned on, and contacts, the axial pocket wall 50, the radial pocket wall 52, and the insert pocket floor 56 when assembled to the cartridge 10 using the threaded fastener 72.

The radial cartridge clearance surface 36 extends from the cartridge main body second end 24, toward the cartridge main body first end 22, and to the radial cartridge floor 38 and from the axial cartridge wall 42 to the second cartridge wall 44. In the illustrated embodiment, the radial cartridge clearance surface 36 is a concave fillet 74. In practice, the concave fillet 74 should have a diameter that is greater than the diameter of the workpiece on which work is being completed to avoid contact between the radial cartridge clearance surface 36 and the workpiece.

The radial cartridge floor 38 extends from the cartridge main body first end 22 toward the cartridge main body second end 24 and is parallel to the cartridge main body lengthwise axis 21. In the embodiment shown, the radial cartridge floor 38 extends from the cartridge main body first end 22 to the radial cartridge clearance surface 36.

The cartridge ceiling 40 extends from the cartridge main body first end 22 to the cartridge main body second end 24. The cartridge ceiling 40 has cartridge ceiling first portion 76 and a cartridge ceiling second portion 78. The cartridge ceiling first portion 76 extends from the cartridge main body first end 22, toward the cartridge main body second end 24, and to the cartridge ceiling second portion 78. The cartridge ceiling second portion 78 extends from the cartridge ceiling first portion 76 to the insert pocket floor 56 and to the cartridge main body second end 24. The cartridge ceiling first portion 76 is disposed at a first angle 79 relative to the second cartridge wall 44. The cartridge ceiling second portion 78 is disposed at a second angle 81 relative to the second cartridge wall 44 that is different than the first angle 79. The first angle 79 can be any suitable angle, such as those between 220 degrees and 260 degrees, those substantially equal to 240 degrees, and any other angle considered suitable for a particular embodiment. The second angle 81 can be any suitable angle, such as those between 80 degrees and 100 degrees, those substantially equal to 90 degrees, and any other angle considered suitable for a particular embodiment.

The axial cartridge wall 42 extends from the cartridge main body first end 22 to the cartridge main body second end 24. The second cartridge wall 44 extends from the cartridge main body first end 22 to the insert pocket floor 56. In the illustrated embodiment, the axial cartridge wall 42 and the second cartridge wall 44 are parallel to the cartridge main body lengthwise axis 21. However, in alternative embodiments, an axial cartridge wall and/or a second cartridge wall can be disposed at any suitable angle relative to a main body lengthwise axis 21.

The first cartridge chamfer 46 extends from the axial cartridge wall 42 to the radial cartridge floor 38 and from the cartridge main body first end 22 to the radial cartridge clearance surface 36. The first cartridge chamfer 46 is interrupted by the cartridge main body passageway 32. The second cartridge chamfer 48 extends from the second cartridge wall 44 to the radial cartridge floor 38 and from the cartridge main body first end 22 to the radial cartridge clearance surface 36.

While the cartridge 10 and the cutting tool 12 (e.g., indexable cutting insert 14) have been illustrated as having particular structural arrangements, a cartridge and cutting tool can have any suitable structural arrangement and selection of a suitable structural arrangement can be based on various considerations, such as the intended use of a cartridge and/or a cutting tool. For example, alternative embodiments can include square cutting tools, diamond cutting tools, and any other cutting tool considered suitable for a particular embodiment. Furthermore, while cartridge 10 has been illustrated as including various chamfers and other features (e.g., for clearance purposes), such chamfers and other features can be omitted from a cartridge.

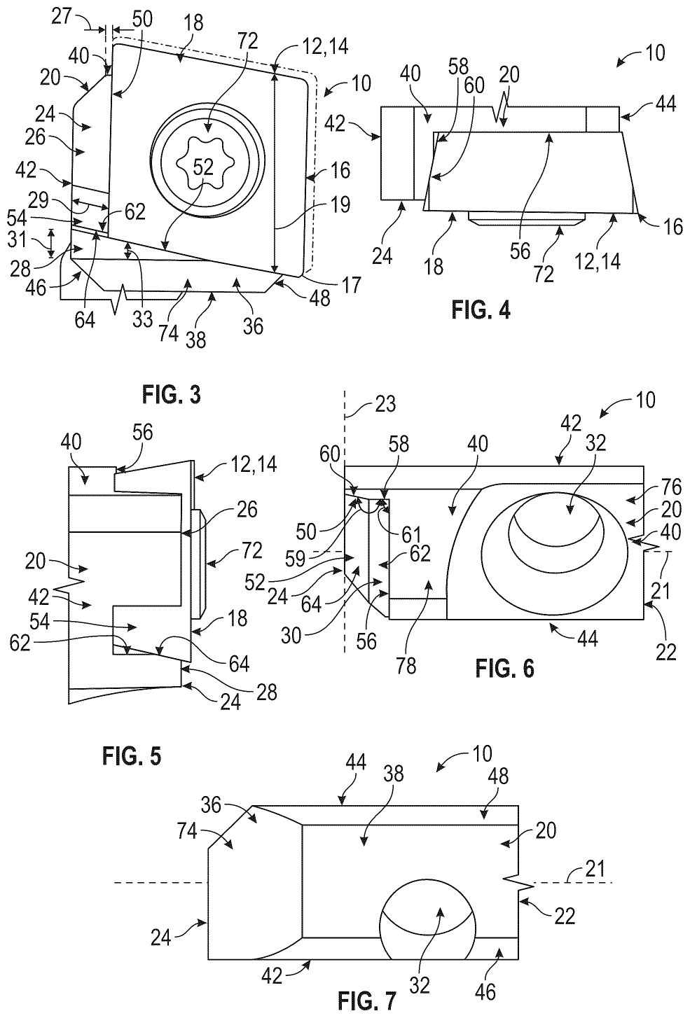

Conventional cartridges include a cutting tool, such as an insert, in which the length of the rake face is parallel, or substantially parallel, to a cartridge lengthwise axis, in which case tolerance stackup can impact overall cutting of a workpiece. In addition, in conventional cartridges the radial cartridge floor and the radial pocket wall are located on the side of an insert that is not the active cutting edge, which allows insert cutting edges to change position when inserts are exchanged or indexed due to varying tolerances in the inserts. The cartridge 10 shown in FIGS. 1 through 11 includes structural features that position the insert pocket floor 56 parallel to the cartridge main body second end 24 and perpendicular to the cartridge main body lengthwise axis 21 such that the cutting edge 16 of the cutting tool 12 is parallel to the first terminal wall 26, the rake face 18 of the cutting tool 12 is perpendicular to the cartridge main body lengthwise axis 21, and the rake face 18 is perpendicular to the radial pocket wall 52 (e.g., radial pocket wall first portion 62) and the radial cartridge floor 38. As a result, the rake face length 19 of the cutting tool 12 is disposed at an angle (e.g., perpendicular) relative to the cartridge main body lengthwise axis 21 and the cutting edge 16 and cutting point 17 of the cutting tool 12 are positioned within the tool body central recess 138, as described in more detail herein, to cut a workpiece. By placing the radial pocket wall 52 on the same side of the cartridge 10 as the active cutting point 17 and the radial cartridge floor 38, the tolerance stackup when exchanging inserts is nearly eliminated because the insert seats against the axial pocket wall 50 and the radial pocket wall 52 regardless of tolerance, as shown in phantom lines in FIG. 3. This allows for more accurate cutting diameters because the tolerance on the diameter is then primarily determined by the tolerance on the cartridge 10 and the relative cartridge pocket in the tool body, as described in more detail herein.

The cartridges described herein, and the associated tool assemblies, are considered advantageous relative to conventional cartridges and tool assemblies since they avoid the issues associated with tolerance stackup and allow for more accurate cutting diameters. For example, in the cartridges described herein, variations in the tolerance of a cutting tool will have minimal influence on the cutting diameter as a result of the cutting edge and the cutting point of the cutting tool being positioned in the same location when the cutting tool is installed in the cartridge. The structural arrangement of the cartridge and the tool assembly, such as the insert pocket seating surface being on the same side of the cartridge as a workpiece, the active cutting edge of the cutting tool, and the radial cartridge floor and the arrangement of the cartridge pocket floor relative to the tool body central axis, as described in more detail herein, are some of the features that assist with reducing, or eliminating, tolerance stackup when exchanging inserts within a cartridge. The tolerance on the diameter is generally determined by the tolerances on a cartridge and a cartridge pocket of a tool body.

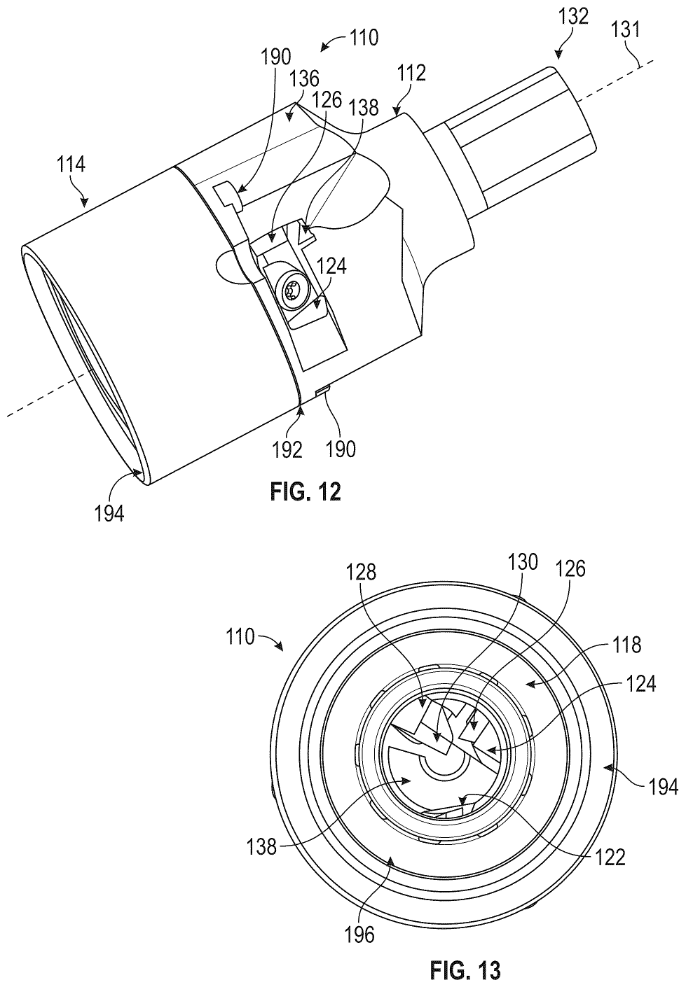

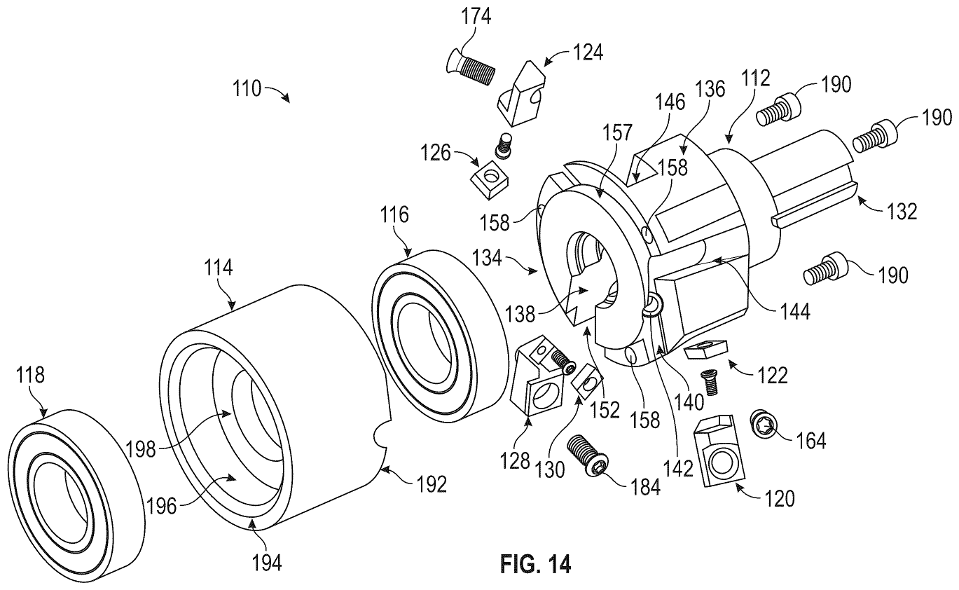

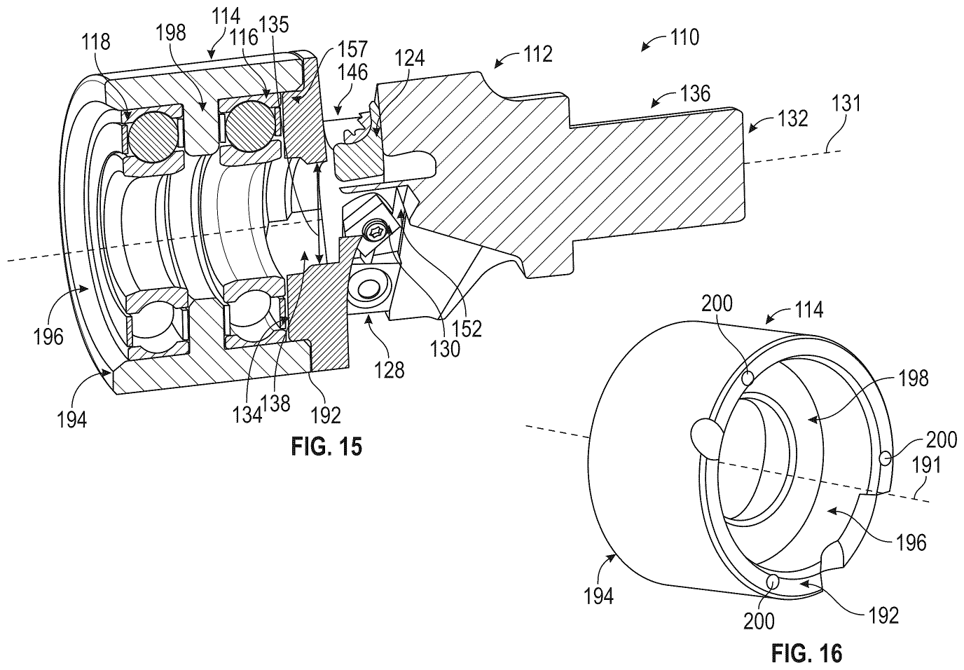

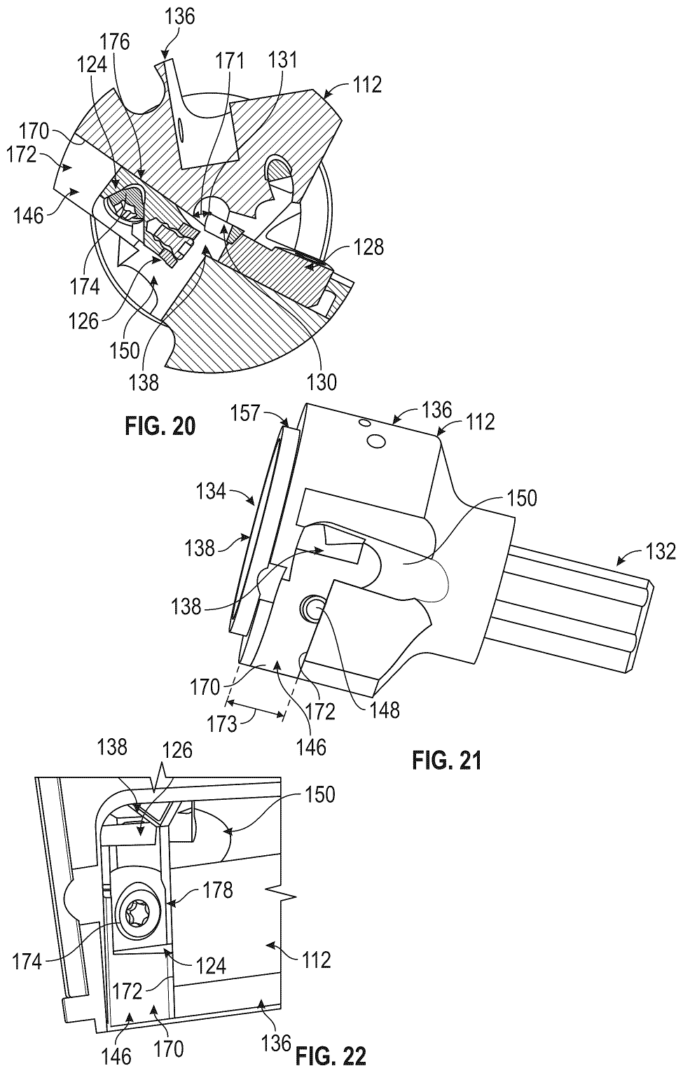

FIGS. 12 through 25 illustrate an example tool assembly 110 that includes a cartridge for a cutting tool. The tool assembly 110 has a tool body 112, a bearing housing 114, a first bearing 116, a second bearing 118, a first cartridge 120 for a first cutting tool 122, a second cartridge 124 for a second cutting tool 126, and a third cartridge 128 for a third cutting tool 130. Each of the first cartridge 120 and the second cartridge 124 is similar to the cartridge 10 illustrated in FIGS. 1 through 11 and described above, except as detailed below. The third cartridge 128 is different than the first cartridge 120 and the second cartridge 124 (e.g., the third cartridge 128 is a conventional cartridge). While the tool assembly 110 has been illustrated as including a first cartridge 120, a second cartridge 124, and a third cartridge 128, a tool assembly can include any suitable number of cartridges and/or cutting tools, such as zero, one, more than one, two, a plurality, three, four, five, and more than five.

The tool body 112 is rotatable around a tool body central axis 131 and has a tool body first end 132, a tool body second end 134, a tool body periphery 136, a tool body central recess 138, a first cartridge pocket 140, a first cartridge passageway 142, a first chip pocket 144, a second cartridge pocket 146, a second cartridge passageway 148, a second chip pocket 150, a third cartridge pocket 152, a third cartridge passageway 154, a third chip pocket 156, a tool body projection 157, and a plurality of attachment passageways 158. The tool body central recess 138 extends from the tool body second end 134 toward the tool body first end 132 and receives a workpiece. In the embodiment shown, the tool body central recess 138 has a first inside diameter 133, a second inside diameter 135 that is less than the first inside diameter 133, and a tapered recess base 137.

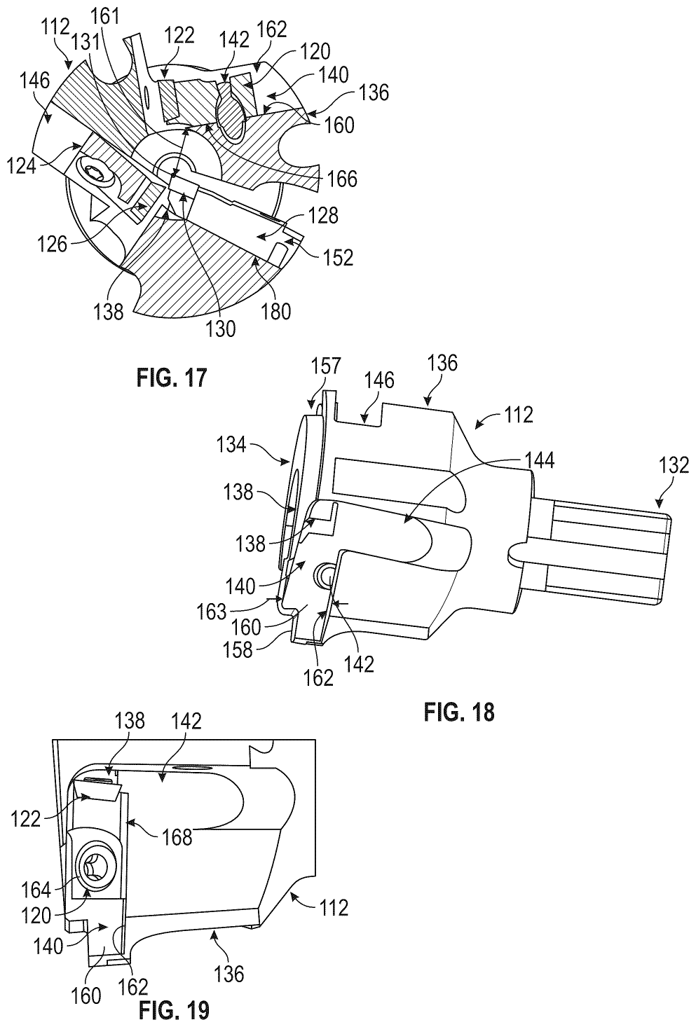

As shown in FIGS. 17, 18, and 19, the first cartridge pocket 140 is disposed between the tool body first end 132 and the tool body second end 134 and extends from the tool body periphery 136 and to the tool body central recess 138. The first cartridge pocket 140 has a first cartridge pocket floor 160 and a first cartridge pocket wall 162. The first cartridge pocket floor 160 is disposed a first distance 161 from the tool body central axis 131. The first cartridge pocket wall 162 is disposed a first distance 163 from the tool body second end 134. The first cartridge passageway 142 extends from the first cartridge pocket floor 160 and the first cartridge pocket wall 162 and to the tool body periphery 136. The first cartridge passageway 142 receives a threaded fastener 164 such that the first cartridge 120 can be releasably attached to the tool body 112. The first chip pocket 144 extends from the first cartridge pocket 140 and the tool body central recess 138, toward the tool body first end 132, and to the tool body periphery 136.

The first cartridge 120 is disposed within the first cartridge pocket 140, extends into the tool body central recess 138, and is attached to the tool body 112 using the threaded fastener 164. The first cartridge 120 is disposed within the first cartridge pocket 140 such that the radial cartridge floor 166 of the first cartridge 120 contacts the first cartridge pocket floor 160 and the axial cartridge wall 168 of the first cartridge 120 contacts the first cartridge pocket wall 162. This structural arrangement results in the first cartridge pocket floor 160 defining the cutting diameter of the first cutting tool 122 and the first cartridge passageway 142 defining the height of the first cutting tool 122 within the tool body central recess 138. In the embodiment shown, the first cartridge 120 positions the first cutting tool 122 within the tool body central recess 138 to reduce the diameter of a first portion of a workpiece during cutting.

As shown in FIGS. 20, 21, and 22 the second cartridge pocket 146 is disposed between the tool body first end 132 and the tool body second end 134 and extends from the tool body periphery 136 and to the tool body central recess 138. The second cartridge pocket 146 has a second cartridge pocket floor 170 and a second cartridge pocket wall 172. The second cartridge pocket floor 170 is disposed a second distance 171 from the tool body central axis 131 that is less than the first distance 161 the first cartridge pocket floor 160 is disposed from the tool body central axis 131. The second cartridge pocket wall 172 is disposed a second distance 173 from the tool body second end 134 that is greater than the first distance 163 the first cartridge pocket wall 162 is disposed from the tool body second end 134. The second cartridge passageway 148 extends from the second cartridge pocket floor 170 and the second cartridge pocket wall 172 and to the tool body periphery 136. The second cartridge passageway 148 receives a threaded fastener 174 such that the second cartridge 124 can be releasably attached to the tool body 112. The second chip pocket 150 extends from the second cartridge pocket 146 and the tool body central recess 138, toward the tool body first end 132, and to the tool body periphery 136.

The second cartridge 124 is disposed within the second cartridge pocket 146, extends into the tool body central recess 138, and is attached to the tool body 112 using the threaded fastener 174. The second cartridge 124 is disposed within the second cartridge pocket 146 such that the radial cartridge floor 176 of the second cartridge 124 contacts the second cartridge pocket floor 170 and the axial cartridge wall 178 of the second cartridge 124 contacts the second cartridge pocket wall 172. This structural arrangement results in the second cartridge pocket floor 170 defining the cutting diameter of the second cutting tool 126 and the second cartridge passageway 148 defining the height of the second cutting tool 126 within the tool body central recess 138. In the embodiment shown, the second cartridge 124 positions the second cutting tool 126 within the tool body central recess 138 to reduce the diameter of a second portion of a workpiece during cutting.

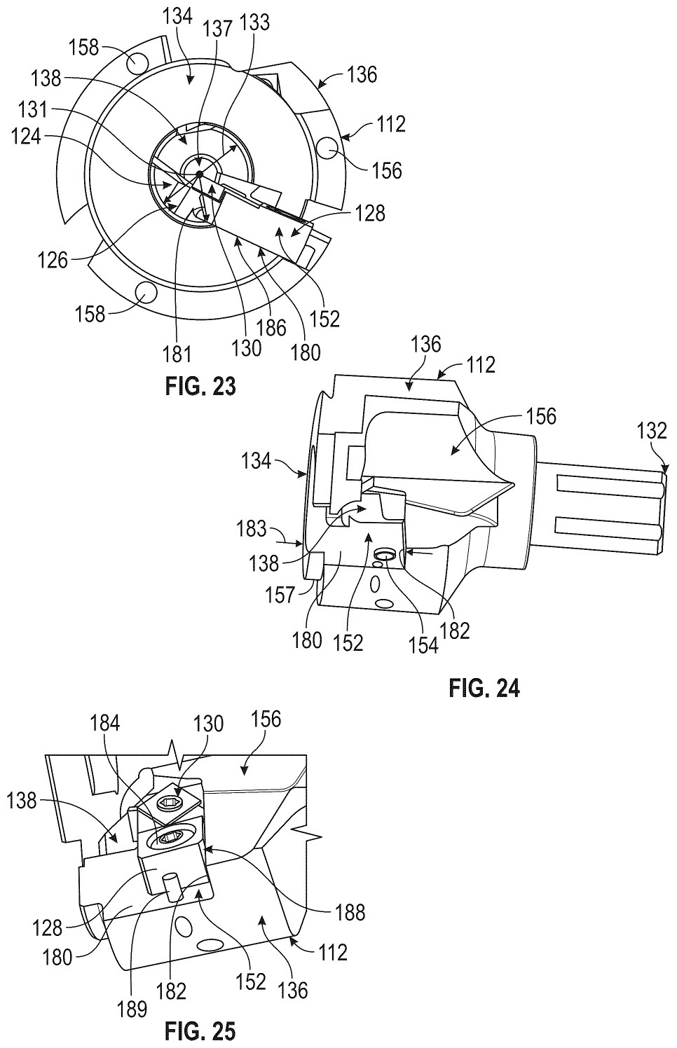

As shown in FIGS. 23, 24, and 25 the third cartridge pocket 152 extends from the tool body second end 134 toward the tool body first end 132 and extends from the tool body periphery 136 to the tool body central recess 138. The third cartridge pocket 152 has a third cartridge pocket floor 180 and a third cartridge pocket wall 182. The third cartridge pocket floor 180 is disposed a third distance 181 from the tool body central axis 131 that is different than the first distance 161 the first cartridge pocket floor 160 is disposed from the tool body central axis 131 and different than the second distance 171 the second cartridge pocket floor 170 is disposed from the tool body central axis 131. The third cartridge pocket wall 182 is disposed a third distance 183 from the tool body second end 134 that is greater than the first distance 163 the first cartridge pocket wall 162 is disposed from the tool body second end 134 and greater than the second distance 173 the second cartridge pocket wall 172 is disposed from the tool body second end 134. The third cartridge passageway 154 extends from the third cartridge pocket floor 180 and to the tool body periphery 136. The third cartridge passageway 154 receives a threaded fastener 184 such that the third cartridge 128 can be releasably attached to the tool body 112. The third chip pocket 156 extends from the third cartridge pocket 152 and the tool body central recess 138 and toward the tool body first end 132.

The third cartridge 128 is disposed within the third cartridge pocket 152, extends into the tool body central recess 138, and is attached to the tool body 112 using the threaded fastener 184. The third cartridge 128 is disposed within the third cartridge pocket 152 such that the cartridge floor 186 of the third cartridge 128 contacts the third cartridge pocket floor 180 and the cartridge wall 188 of the third cartridge 128 contacts the third cartridge pocket wall 182. The cartridge floor 186 determines the height of the third cutting tool 130, and the pin 189 that holds the cartridge in place controls the diameter because fastener 184 has clearance inside the cartridge 128. In the embodiment shown, the third cartridge 128 positions the third cutting tool 130 within the tool body central recess 138 to provide a chamfer on a workpiece during cutting.

While the tool body 112 has been illustrated as including a first cartridge pocket 140, a first cartridge passageway 142, a first chip pocket 144, a second cartridge pocket 146, a second cartridge passageway 148, a second chip pocket 150, a third cartridge pocket 152, a third cartridge passageway 154, and a third chip pocket 156, a tool body can define any suitable number of cartridge pockets, cartridge passageways, and/or chip pockets. Selection of a suitable number of cartridge pockets, cartridge passageways, and/or chip pockets to include on a tool body can be based on various considerations such as the intended use of a tool body. Examples of numbers of cartridge pockets, cartridge passageways, and/or chip pockets considered suitable to include on a tool body include one, more than one, two, a plurality, three, four, more than four, and any other number considered suitable for a particular embodiment.

The tool body projection 157 extends from the tool body second end 134 and away from the tool body first end 132 and is received by the bearing housing 114, as described in more detail herein. Each passageway of the plurality of attachment passageways 158 extends from the tool body second end 134, toward the tool body first end 132, and receives a threaded fastener of the plurality of threaded fasteners 190, as described in more detail herein.

The bearing housing 114 is attached to the tool body 112 (e.g., tool body second end 134) using a plurality of threaded fasteners 190, each of which is disposed through a distinct passageway of the plurality of attachment passageways 158. The bearing housing 114 has a bearing housing central axis 191, a bearing housing first end 192, a bearing housing second end 194, a bearing housing central passageway 196, a bearing housing projection 198, and a plurality of threaded recesses 200. The bearing housing central axis 191 is coaxial with the tool body central axis 131, when assembled with the tool body 112. The bearing housing first end 192 contacts the tool body second end 134. The bearing housing central passageway 196 extends from the bearing housing first end 192 to the bearing housing second end 194. The tool body projection 157 is disposed within the bearing housing central passageway 196. The bearing housing projection 198 extends into the bearing housing central passageway 196 and is disposed between the bearing housing first end 192 and the bearing housing second end 194. Each threaded recess of the plurality of threaded recesses 200 extends from the bearing housing first end 192, toward the bearing housing second end 194, and receives a threaded fastener of the plurality of threaded fasteners 190 to releasably attach the bearing housing 114 to the tool body 112.

The first bearing 116 is disposed within, and attached to, the bearing housing 114 between the bearing housing projection 198 and the bearing housing first end 192. In the embodiment shown, the first bearing 116 is disposed within the bearing housing central passageway 196 between the bearing housing projection 198 and the tool body 112 (e.g., tool body second end 134). The second bearing 118 is disposed within, and attached to, the bearing housing 114 between the bearing housing projection 198 and the bearing housing second end 194. In the embodiment shown, the second bearing 118 is disposed within the bearing housing central passageway 196 between the bearing housing projection 198 and the bearing housing second end 194. Each of the first bearing 116 and the second bearing 118 are sealed bearings.

The inclusion of a bearing housing and first and second bearings is considered advantageous at least because they provide a mechanism for guiding a workpiece (e.g., flexible cable) to the cutting tools included in a tool assembly, provide a stable method of holding flexible workpieces, and maintaining the concentricity of the workpiece during cutting. Furthermore, the inclusion of a bearing housing and first and second bearings reduces, or eliminates, friction between a workpiece and a cutting tool, which can result in thermal deformation of the workpiece.

Those with ordinary skill in the art will appreciate that various modifications and alternatives for the described and illustrated embodiments can be developed in light of the overall teachings of the disclosure, and that the various elements and features of one example described and illustrated herein can be combined with various elements and features of another example without departing from the scope of the invention. Accordingly, the particular examples disclosed herein have been selected by the inventor(s) simply to describe and illustrate examples of the invention and are not intended to limit the scope of the invention or its protection, which is to be given the full breadth of the appended claims and any and all equivalents thereof.

What is claimed is:

1. A cartridge for a cutting tool comprising:
a cartridge main body having a cartridge main body first end, a cartridge main body second end, a first terminal wall, a second terminal wall, an insert pocket, a radial cartridge floor, a cartridge main body passageway, and a cartridge main body recess;
each of the first terminal wall and the second terminal wall disposed on the cartridge main body second end;
the insert pocket extending from the cartridge main body second end toward the cartridge main body first end and having an axial pocket wall, a radial pocket wall, and an insert pocket floor, the axial pocket wall extending from the first terminal wall, toward the cartridge main body first end, and to the insert pocket floor, the radial pocket wall extending from the second terminal wall, toward the cartridge main body first end, and to the insert pocket floor, the radial pocket wall disposed at an angle relative to the radial cartridge floor between 0 degrees and 20 degrees;
the cartridge main body passageway disposed between the cartridge main body first end and the insert pocket floor; and
the cartridge main body recess extending from the insert pocket floor and toward the cartridge main body first end.

2. The cartridge of claim 1, wherein the cartridge main body has a radial cartridge clearance surface;
the radial cartridge clearance surface extending from the cartridge main body second end, toward the cartridge main body first end, and to the radial cartridge floor; and
the radial cartridge floor extending from the radial cartridge clearance surface to the cartridge main body first end.

3. The cartridge of claim 2, wherein the radial cartridge clearance surface is a concave fillet.

4. The cartridge of claim 2, wherein the radial pocket wall is disposed at an angle relative to the radial cartridge clearance surface that is substantially equal to 10 degrees.

5. The cartridge of claim 2, wherein the cartridge main body has an axial cartridge wall and a second cartridge wall; and
wherein the radial cartridge clearance surface extends from the axial cartridge wall to the second cartridge wall.

6. The cartridge of claim 1, wherein the radial cartridge floor extends from the cartridge main body first end toward the cartridge main body second end; and
wherein the axial pocket wall is disposed at an angle relative to the radial cartridge floor that is substantially equal to 90 degrees.

7. The cartridge of claim 1, wherein the axial pocket wall is disposed at an angle relative to the radial pocket wall that is substantially equal to 100 degrees.

8. The cartridge of claim 1, wherein the axial pocket wall has an axial pocket wall first portion and an axial pocket wall second portion disposed at an angle relative to the axial pocket wall first portion that is greater than 180 degrees.

9. The cartridge of claim 1, wherein the radial pocket wall has a radial pocket wall first portion and a radial pocket wall second portion disposed at an angle relative to the radial pocket wall first portion that is greater than 180 degrees.

10. The cartridge of claim 1, wherein the axial pocket wall has an axial pocket wall first portion and an axial pocket wall second portion, the axial pocket wall first portion extending from the insert pocket floor and toward the cartridge main body second end, the axial pocket wall second portion extending from the axial pocket wall first portion and to the cartridge main body second end.

11. The cartridge of claim 1, wherein the radial pocket wall has a radial pocket wall first portion and a radial pocket wall second portion, the radial pocket wall first portion extending from the insert pocket floor and toward the cartridge main body second end, the radial pocket wall second portion extending from the radial pocket wall first portion and to the cartridge main body second end.

12. The cartridge of claim 1, wherein the axial pocket wall has an axial pocket wall depth extending from the cartridge main body second end to the insert pocket floor; and
wherein the radial pocket wall has a radial pocket wall depth extending from the cartridge main body second end to the insert pocket floor that is equal to the axial pocket wall depth.

13. The cartridge of claim 1, wherein the insert pocket floor is disposed at an angle relative to the radial cartridge floor that is substantially equal to 90 degrees.

14. The cartridge of claim 1, wherein the cartridge main body has a cartridge main body lengthwise axis; and
wherein the insert pocket floor is disposed perpendicular to the cartridge main body lengthwise axis.

15. The cartridge of claim 1, wherein the cartridge main body passageway is countersunk.

16. The cartridge of claim 1, wherein the cartridge main body has a cartridge ceiling extending from the cartridge main body first end to the cartridge main body second end, the cartridge ceiling having a cartridge ceiling first portion and a cartridge ceiling second portion, the cartridge ceiling first portion extending from the cartridge main body first end toward the cartridge main body second end, the cartridge ceiling second portion extending from the cartridge ceiling first portion to the insert pocket floor;
wherein the cartridge main body has a second cartridge wall;
wherein the cartridge ceiling first portion is disposed at a first angle relative to the second cartridge wall; and
wherein the cartridge ceiling second portion is disposed at a second angle relative to the second cartridge wall that is different than the first angle.

17. The cartridge of claim 16, wherein the first angle is substantially equal to 240 degrees.

18. The cartridge of claim 17, wherein the second angle is substantially equal to 90 degrees.

19. A cartridge for a cutting tool comprising:
a cartridge main body having a cartridge main body first end, a cartridge main body second end, a radial cartridge floor, a first terminal wall, a second terminal wall, an insert pocket, a radial cartridge floor, a cartridge main body passageway, and a cartridge main body recess;
each of the first terminal wall and the second terminal wall disposed on the cartridge main body second end;
the insert pocket extending from the cartridge main body second end toward the cartridge main body first end and having an axial pocket wall, a radial pocket wall, and an insert pocket floor, the axial pocket wall extending from the first terminal wall, toward the cartridge main body first end, and to the insert pocket floor, the axial pocket wall disposed at a first angle relative to the radial cartridge floor substantially equal to 90 degrees, the radial pocket wall extending from the second terminal wall, toward the cartridge main body first end, and to the insert pocket floor, the radial pocket wall disposed at a second angle relative to the radial cartridge floor between 0 degrees and 20 degrees, the insert pocket floor disposed at a third angle relative to the radial cartridge floor substantially equal to 90 degrees;
the cartridge main body passageway disposed between the cartridge main body first end and the insert pocket floor; and
the cartridge main body recess extending from the insert pocket floor and toward the cartridge main body first end.

20. A tool assembly comprising:
a tool body rotatable around a tool body central axis, the tool body having a tool body first end, a tool body second end, a tool body periphery, a tool body central recess, a cartridge pocket, and a chip pocket, the tool body central recess extending from the tool body second end toward the tool body first end, the cartridge pocket extending from the tool body periphery and to the tool body central recess, the chip pocket extending from the cartridge pocket and toward the tool body first end;
a bearing housing attached to the tool body, the bearing housing having a bearing housing central axis, a bearing housing first end, a bearing housing second end, a bearing housing central passageway, and a bearing housing projection extending into the bearing housing central passageway;
a first bearing disposed within the bearing housing between the bearing housing projection and the tool body; and
a second bearing disposed within the bearing housing between the bearing housing projection and the bearing housing second end.
